(19) United States
(12) Patent Application Publication
(10) Pub. No.: US 2021/0022541 A1
(43) Pub. Date: Jan. 28, 2021

(54) Electric Pressure Cooker Rim Cover

(71) Applicant: Sara Elizabeth Bauer, Missoula, MT (US)

(72) Inventor: Sara Elizabeth Bauer, Missoula, MT (US)

(21) Appl. No.: 16/939,644

(22) Filed: Jul. 27, 2020

Related U.S. Application Data
(63) Continuation of application No. PCT/US20/43135, filed on Jul. 22, 2020.
(60) Provisional application No. 62/879,098, filed on Jul. 26, 2019.

(51) Int. Cl. A47J 27/09; A47J 27/086

(52) U.S. Cl. CPC A47J 27/09; F24C 7/00; A47J 27/086

(57) ABSTRACT

A pot protecting ring accessory for use with an electric pressure cooker when the lid is open and being used for activities like adding ingredients, sautéing, searing, serving, boiling, stirring, or other heating. The protective ring is desirably heat resistant and may be constructed of a rigid or semi-rigid material or may be a silicone ring with more flexibility. The protective ring shields the cooker's upper rim and particularly the drain channel and space between the inner cooking pot and the outer housing. Protecting the heat element and pressure sealing area from debris and boil overs extends the life and safe use of the pressure cooker. The ring doubles as a heat guard between the user's hand and the hot cooker body and the ring may be grabbed or pressed to create friction with the inner pot brim, inhibiting its spinning during cooking operations like stirring and serving.

### CROSS-REFERENCE TO RELATED APPLICATIONS

This patent application claims priority under 35 U.S.C. § 119(e) to U.S. Patent Application Ser. No. 62/879,098, entitled “Electric Pressure Cooker Rim Cover”, and filed on Jul. 26, 2019, which application is now pending. The entire disclosure of that provisional patent application is hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### 1. Field of the Invention

This invention relates to accessories for multi-function, counter-top pressure cooker appliances, and more particularly to covers that shield and protect the heating elements, the pot rim, rim structures and lid receiving recesses of the pressure cooker appliance.

### 2. Description of the Related Art

Counter-top pressure cookers have become a staple in the small electric appliance industry in recent years. Instant Pot® is one popular example of these counter-top pressure cookers which commonly include multifunction cooking options. Applicant hereby incorporates herein by this reference, the entirety of the Instant Pot® Programmable Smartcooker User Manual found at this link: https://instantpot.com/wp-content/uploads/2017/07/IP-Smart-Manual-English-V-20.pdf and Instant Pot® Max manual at this link: https://instantpot.com/wp-content/uploads/2017/12/Max-6-Quart-Manual-June-22-2018-V2-reference.pdf. Other brands include Insignia, NuWave, Power Pressure Cooker, Gourmia, Aucma, Ninja, Megachef, Pampered Chef, Cuisinart, Farberware and many more. Throughout this application, Applicant references Instant Pot® as an example but any electric pressure cooker could be substituted where Instant Pot® is specifically discussed.

These electric, multi-functional cookers combine a Pressure Cooker, Slow Cooker, Rice Cooker, Porridge Maker, Steamer, Sauté Pan, Yogurt Maker, Food Warmer and more. In one pot, the appliance offers the user an ability to complete cooking tasks such as: braising, pressure cooking, stewing, steaming, simmering, slow cooking, sauté/browning, fermenting, making yogurt and keeping warm. This new generation of kitchen appliance has inspired an entire segment of the kitchen industry with numerous models of the counter-top appliances and the development of dedicated smart apps and specialty appliance and recipe forums.

While the multi-function cooking devices are offered in various sizes and capacities with wide ranging options and smart features, at a minimum, they typically include an inner cooking pot and an outer, heating element housing and cooker body with a lid. The inner cooking pot is removable and usually made of stainless steel but could also be made of ceramic or other nonstick material. The outer, heating element housing receives the inner cooking pot and is usually constructed of cast iron and other composite materials. The cooker body surrounds the outer, heating element housing with the electrical components for operation. Along the top of the cooker body is a housing rim and slot. This creates a gap or space as the channels in the rim are constructed to receive the lid and complete the sealing mechanisms of the pressure cooker. There is also some space that is created between the inner cooking pot and the outer element housing. Users must be very cautious when adding ingredients to the inner cooking pot or during the cooking, stirring and serving steps, to ensure that the food and liquid content does not spill into the outer element housing. When food or liquids penetrate this area of the cooking device, they can cause damage to the appliance or cause the device functions to fail. Finally, a removable lid completes the pressure cooker. Users are cautioned to keep the entire top rim of the pot and device clean to ensure proper sealing of the lid and safe function of the lid during pressure cooking.

### BRIEF SUMMARY OF THE INVENTION

When the multi-function pressure cooking device is opened to insert ingredients for any cooking function or when the cooker is used in one of the open-top cooking operations, such as sautéing, the top housing rim and space between the heating element housing and the inner cooking pot is exposed. Whether the inner pot is in place or not, this area is still exposed and catches spills and food debris. Additionally, spills that reach the brim of the inner pot may dribble down and into the housing and come in contact with the heating element which will compromise the cooking device and may eventually result in malfunction. The present invention seeks to prevent any spills or drips from reaching the components or interior gap near the rim of the pot or the exterior brim of the inner pot and thus the heating element housing. The present invention provides a protective ring to cover the drain channel and opening between the inner cooking pot and outer element housing of electric pressure cookers with an option to use the drain channel for draining condensation while keeping larger food particles out.

The present invention acts as a pot protector and splash shield and is particularly useful with the cooking device at times when the pressure cooker lid is removed such as when adding ingredients, or during sautéing, searing, browning, boiling, braising, slow cooking, stewing, simmering, keeping warm, serving and any cooking tasks that call for heating without the lid, or call for the lid to be temporarily removed. The protective ring can also provide beneficial barrier functions when the cooker is turned off such as when a bowl or a steamer is placed above water in the inner pot.

The protective ring has an added benefit of permitting the user to prevent the inner pot from spinning during the process of using a utensil within the inner pot, such as during stirring or sautéing. In some embodiments, the user may apply pressure around the top of the rim of the cooking pot in order to discourage spinning. In these embodiments, the ring body has sufficient top surface space and is heat resistant so that a user can rest her hand atop the ring surface in order to apply friction pressure between the rim cover and the upper brim of the inner pot to prevent the inner pot from spinning in the housing while the user is stirring, scooping, or scraping the interior. In some embodiments, such as those constructed of silicone, the inner ledge will further enhance the user's ability to safely grab the inner pot and prohibit the spinning.

The removable, protective ring also provides protection to the cooking device even when the device is used for pressure cooking or fermenting because some ingredients may still need to be added over the rim of the outer element housing and the completed recipe is likely to be served or scooped directly from the cooking device.

Thus, the present invention helps to keep cookers clean and helps protect them from damage. It accomplishes this by helping to protect the heat element and the exterior housing from spills and food debris and residue. By using the protective ring, the user can keep the drain channel clean while still allowing its use if desired and keep the top rim of the cooking device clear of food residue to permit better sealing during pressure cooking.

More specifically, and in a presently preferred embodiment, by way of example and not necessarily by way of limitation, a user will apply the ring over the rim of the cooking device prior to adding ingredients to the pot. Then, leaving the ring in place, the user will perform cooking steps in a normal fashion. The ring will protect the rim of the cooking device during at least the preparing, stirring, and serving steps of cooking. The ring serves as a splatter guard and protects the internal mechanisms of the cooking device from cooking residue spattered, sprayed or popped out of the pot. When the cooking device is in use as a pressure cooker, the present invention must be removed from the rim prior to the lid being secured to the cooker. The rim would also be advantageously removed when the primary lid is applied in a non-sealing manner such as when the device is boiling, double boiling, or slow cooking a recipe. Once the lid is removed and the contents of the pot are to be served from the cooking device, the ring is once again installed in position to encircle and protect the cooker rim and space between the inner pot and outer housing.

In some cooking applications, an optional glass lid or semi-sealing lid might be used with the countertop cooker appliance. In some instances, the protective ring may remain in place around the circumference of the inner pot while the lid is applied overtop. This should only occur if the cooking device is off, in warming mode or yogurt mode and is not recommended while boiling. The protective ring could provide some protection for directing liquid and condensation toward the space between the inner pot and the outer housing while using a semi-sealing lid.

When the cooking is complete, the rim cover is removed and cleaned by hand or in a dishwasher. The rim cover will be stored and reused each time the cooking device is used.

More specifically, and in a presently preferred embodiment, by way of example and not necessarily by way of limitation, the rim will ideally have an outside diameter in the range of 190.5 mm-206.4 mm (7.5-16 inches) and an inside diameter in the range of 177.8 mm-330.2 mm (7-13 inches) with a ring body spanning the outer diameter and inner diameter. Other ranges are contemplated to be necessary as the cooking device appliances vary in available sizes and volumes. The ring body of the protective ring will rest at a substantially perpendicular angle to the vertical wall of the inner pot or cooker appliance. The outer diameter portion of the ring will additionally comprise a lip projecting at an angle that is substantially perpendicular to the ring body and also substantially parallel to the inner pot sidewall. In the preferred embodiment, the ring body width will occur in the range of 38.1 mm-88.9 mm (1.5-3.5 inches) across. Other widths will be desirable for cooking appliances with thicker heating element housings or inner pots with thicker walls. When in use, the lip will project in a downward direction along the exterior portion of the cooking device and extend about 6.35 mm-31.75 mm (0.25-1.25 inches), about ¼ of the ring body width. The lip helps to secure the ring in place around the outer portion of the drain channel on the rim of the cooking device. The inner diameter portion of the ring will have a ledge that encircles an opening through which the interior of the pot is accessed for cooking functions. The preferred embodiment for the 6 quart Instant Pot® will have a largest diameter of 273.05 mm (10.75 inches) and an inner ring opening diameter of 214.487 mm (8.44 inches). The height of the device measures 20.64 mm (025 inches) and the opening for the lid fin on either side of the device has a length of 50 mm (1.97 inches) and may be arched or presented in other configurations. The thickness of the ring in this embodiment is approximately 1.5 mm (059 inches) but may vary and should be of minimal thickness, but also sufficiently thick to permit the material used to achieve the objectives stated herein.

The preferred embodiment of the ring protector will include a cut out or recessed void portion to allow use and access to the drain channel. If a lid fin slot is present on a particular pressure cooker model, then that lid fin is not impeded by the rim cover. The rim slot allows condensation to run off of the inside of the lid into the drain channel, if desired. Certain embodiments of the protective ring will complement the features of various models and brands of pressure cookers and may need to permit sufficient circumference to encircle and protect the cooker handle in addition to the rim.

The present invention may optionally be formed of one piece or more than one piece, for example, two pieces. When a two piece configuration is employed, the ring protector is comprised of two half circle pieces which will abut or join to form a complete ring to encircle a rim as described and illustrated herein. A single-piece configuration calls for a complete ring. In either configuration, features to accommodate the lid fin slot and cooker handles may be provided. In either configuration, the outer diameter and inner diameter are such that the ring can encircle the pot. The ring is offered in various sizing options to accommodate variations in the cooker dimensions.

The material of construction can be varied to meet the objectives of the invention but will ideally be inexpensive, food-grade materials, with heat resistant characteristics. The preferred embodiment calls for aesthetically pleasing designs and colors to be employed to please the consumer eye and enhance the attractiveness of the cooking appliance.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration, the advantages and objects of the present invention. Each drawing is referenced by corresponding figure reference characters within the “DETAILED DESCRIPTION OF THE INVENTION” section to follow.

FIG. 1 is a top perspective view of a ring protector according to a first embodiment of the present invention and demonstrating the mode of application onto an electric pressure cooker, counter-top appliance.

FIG. 2 is a bottom perspective view of the first embodiment of the present invention.

FIG. 3 is a first side elevation view of the first embodiment of the present invention.

FIG. 4 is a second side elevation view of the first embodiment of the present invention.

FIG. 5 is a front elevation view of the first embodiment of the present invention.

FIG. 6 is a rear elevation view of the first embodiment of the present invention.

FIG. 7 is a top elevation view of the first embodiment of the present invention.

FIG. 8 is a bottom elevation view of the first embodiment of the present invention.

FIG. 9 is a top perspective view of a second embodiment of the present invention and demonstrating the mode of application onto an electric pressure cooker, counter-top appliance.

FIG. 10 is a bottom perspective view of the second embodiment of the present invention.

FIG. 11 is a first side view of the second embodiment of the present invention.

FIG. 12 is a second side view of the second embodiment of the present invention.

FIG. 13 is a front view of the second embodiment of the present invention.

FIG. 14 is a back view of the second embodiment of the present invention.

FIG. 15 is a top view of the second embodiment of the present invention.

FIG. 16 is a bottom view of the second embodiment of the present invention.

FIG. 17 is a top elevation view of a standard model electric pressure cooker, counter-top appliance according to the prior art, before application of the present invention.

FIG. 18 is a side elevation view of a standard model electric pressure cooker counter-top appliance with the lid propped open according to the prior art before application of the present invention.

### DETAILED DESCRIPTION OF THE INVENTION

The drawings illustrate multiple embodiments of the present invention and their application to one version of a counter-top, electric pressure cooker appliance. The pressure cooker is illustrated for context to show how the present invention functions and meets the objectives further described and illustrated herein.

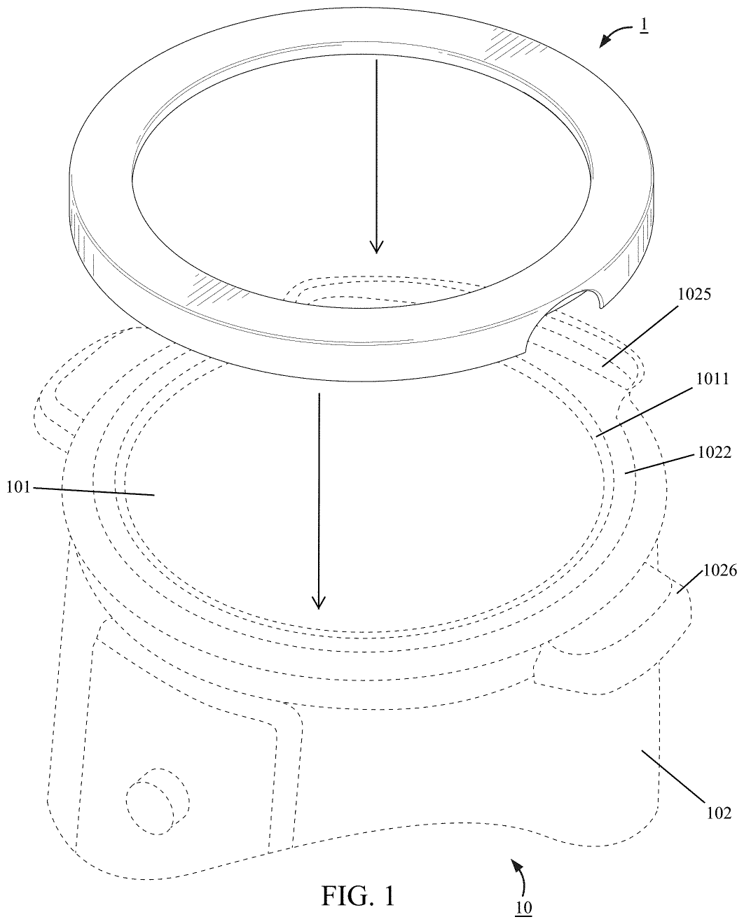

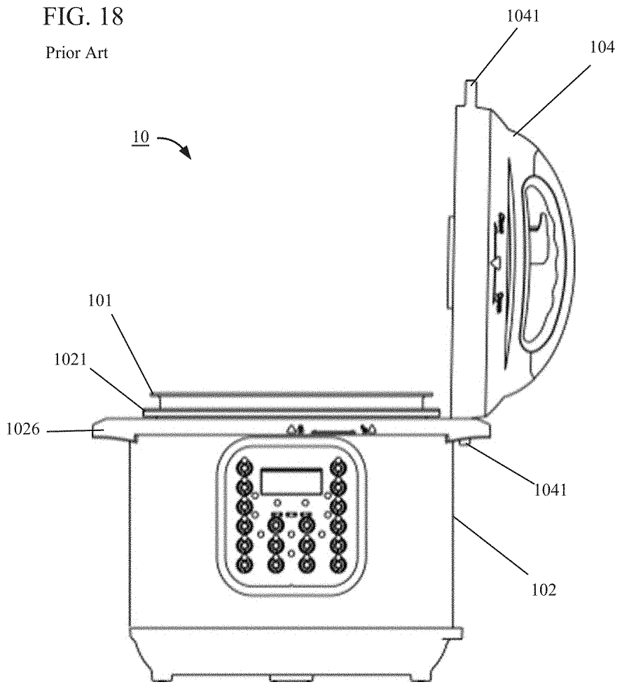

With reference to FIG. 1, a pressure cooker 10 is illustrated in broken lines. Arrows illustrate that a preferred embodiment of the protective ring 1 of the present invention is placed on top of the pressure cooker 10. The pressure cooker has an interior pot 101 and a cooker body 102 to receive the inner pot 101 and a lid (see FIG. 18). The cooker body includes an exterior rim 1021, drain channel 1022, and lid receiving interface 1023.

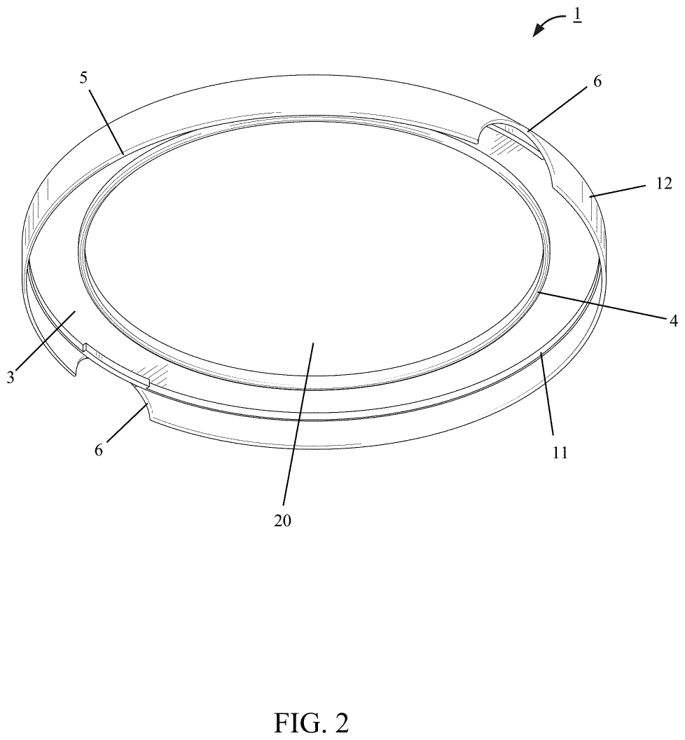

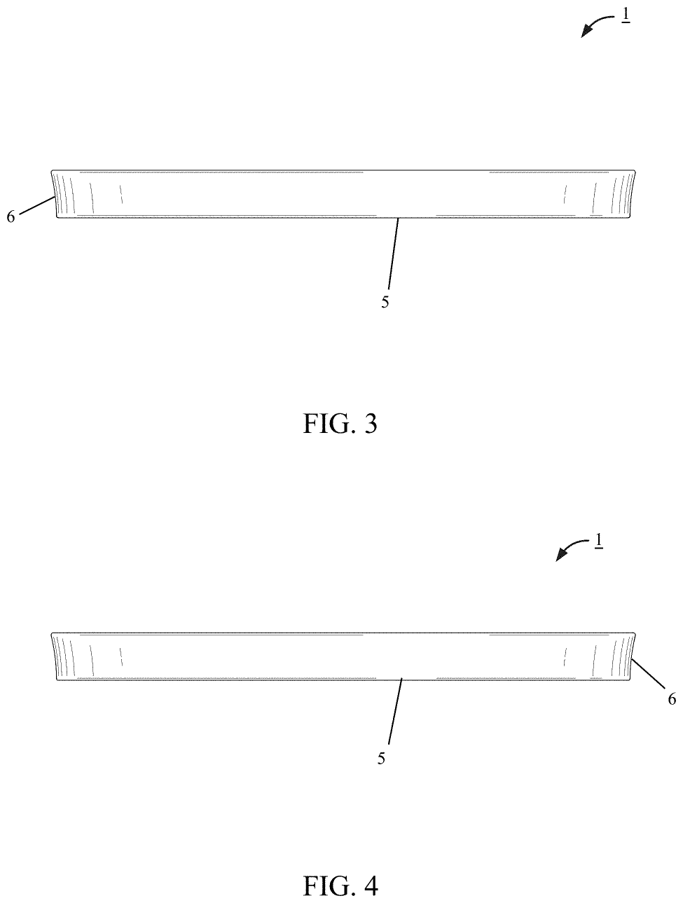

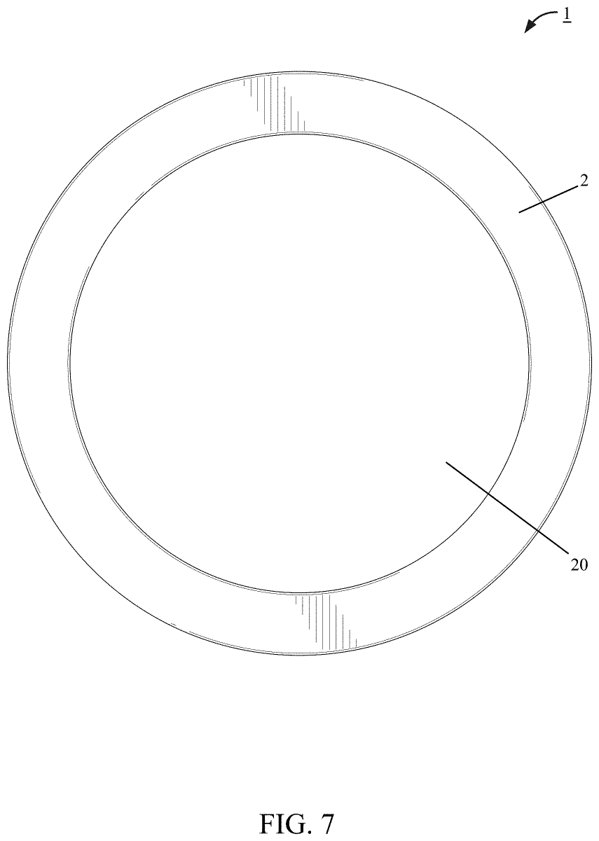

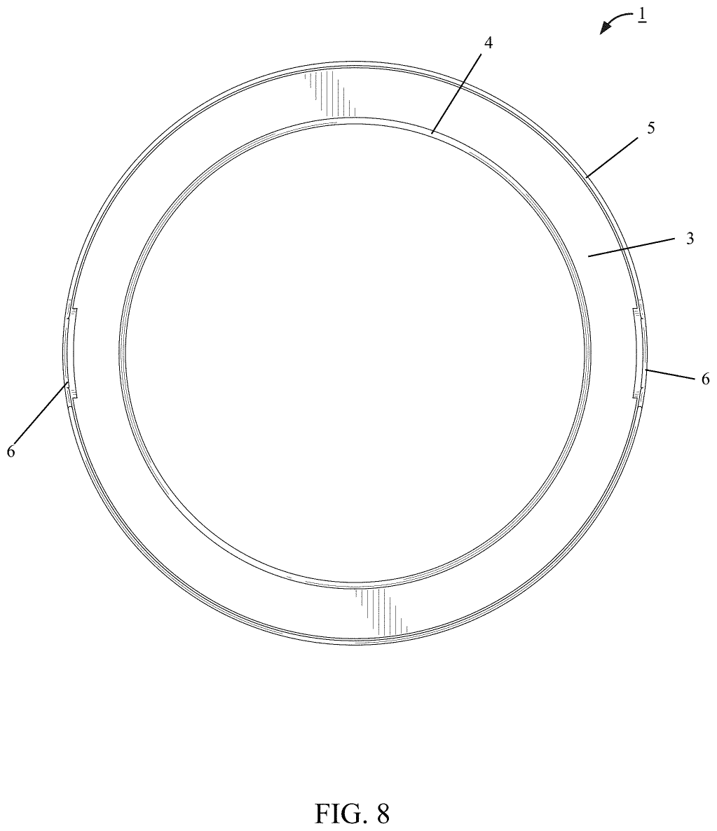

Turning to FIGS. 2-8, the protective ring 1 includes an upper surface 2, a lower surface 3, an inside ledge 4, and outer lip 5, and a lid fin recess 6. The upper surface 2 and lower surface 3 form a ring body that is substantially flat as better viewed in FIGS. 3-6. The upper surface 2 could also have a slight inward decline toward the stir-through void 20. The ring lower surface 3 is substantially planar with the upper surface 2; however, slight additions may be made to the lower surface 3 to interface with the features of the cooker rim and assist the ring in staying in place. The upper surface 2 and lower surface 3 meet on the interior circumference at the inside ledge 4. The upper surface 2 and lower surface 3 meet on the exterior circumference at the outer lip 5. FIG. 2 illustrates one embodiment of the outer lip 5 having an outside wall 12 and an inside wall 11 which each extend substantially perpendicular to the upper surface 2. In the embodiments suited to Instant Pot® brand pressure cookers, the ring is advantageously provided with a lid fin recess 6.

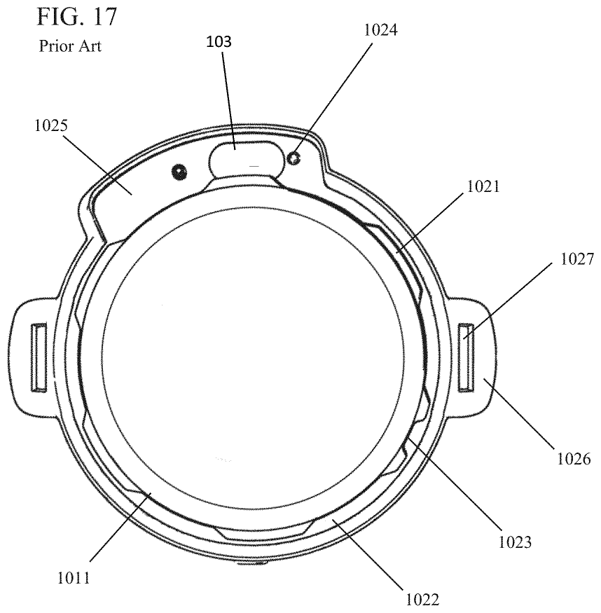

FIGS. 1 and 17 illustrate the top view of one pressure cooker brim area with the inner pot 101 inserted. FIG. 17 shows greater detail of the pressure cooker top area which includes the exterior rim 1021, a drain channel 1022 surrounding the brim of the inner pot 1011, a lid receiving interface 1023, a drain reservoir area 1025 and a drain hole 1024 that releases into a condensation catch 103 located below the drain reservoir area. The pressure cooker handle 1026 is located near the top of the cooker body. In the center area of each handle is located a lid fin receiving slot 1027. Additionally, a horizontal lip that receives the twist sealing lid occurs along the top of the cooking device rim where the outer pot and the heating element housing meet. This space between the exterior housing and the cast iron outer pot creates a catch area where food, crumbs and debris land and dirty the cooking device. When viewing FIG. 1 in conjunction with FIG. 17, one can appreciate how easy it is to spill food and spatter debris into and around the rim of the pressure cooker. FIG. 17 shows the inaccessible nature of the drain channel 1022 and the overhanging features of the exterior pot rim 1021 making it challenging to clean and dry these areas.

The protective ring 1 is applied to the pressure cooker. The protective ring 1 will cover the inner pot rim 1011, the exterior pot rim 1021, the lid receiving interface 1023 and part of the drain channel 1022. A small portion of the drain channel 1022 remains exposed so that the interplay between the protective ring 1 and the drain channel still exploits the benefits of the drain channel, drain hole 1024, drain reservoir 1025 and condensation catch 103 (see FIG. 17). The handles 1026, lid fin receiving slots 1027, the drain reservoir 1025, and drain hole 1024 are still functional. Through the stir-through void 20 of the protective ring 1, the cooker inner pot 101 is still accessible for inserting ingredients, stirring, serving, or scooping or any of the various open-lid functions of the multi-functional cooker.

FIG. 2 illustrates the bottom of the preferred embodiment of the protective ring 1. The ring lower surface 3 terminates interiorly at the inside ledge 4 and terminates exteriorly at the outer lip 5. In this embodiment, two lid fin recesses 6 are provided on opposite sides of one another so that they will best align with the cooker handle 1026 and therefore the lid fin receiving slots 1027 (see FIG. 17).

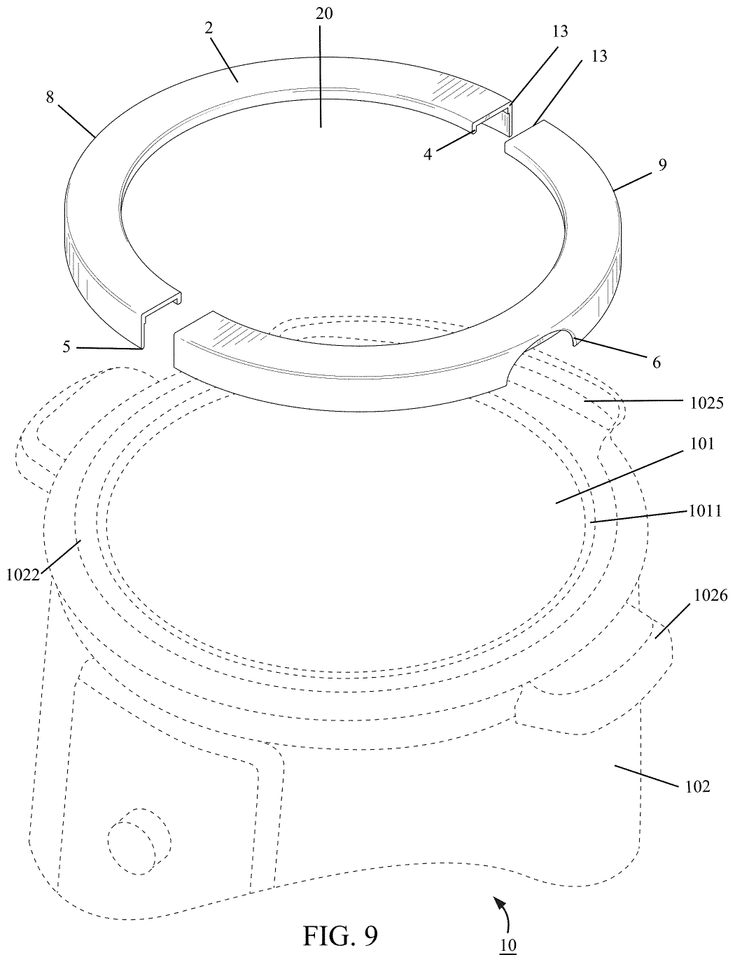

With reference to FIGS. 1 and 9, the protective ring 1 is applied to the pressure cooker even when the lid 104 stands vertically in the lid-receiving void of the handle 1026 illustrated in FIG. 18. The protective ring 1 is applied to this particular pressure cooker for use as illustrated in FIGS. 1 and 9. Then, the cooker is ready to have ingredients added or food served from the cooker 10. The addition of the protective ring 1 to the pressure cooker 10 might also be desirable while boiling, sautéing or browning. The features of a standard, counter-top pressure cooker are visible in FIGS. 1, 9, and 17-18: the inner pot 101 is inserted into the cooker body 102 and the brim areas of the internal pot 101, external pot 1021 and the cooker body 102 are visible. Once the protective ring 1 is applied as indicated in FIGS. 1 and 9, the protective ring 1 will cover the circumference of the inner pot 101 and most of the rim of the external pot 1021 but leave some interface for condensation to return to the drain channel 1022. The covered cooker has its rim components protected from spills, splashes and debris which thereby discourages residue build up that is harmful to the cooker.

The protective ring 1 is also advantageously applied to a pressure cooker in an open configuration with the lid fully removed from the pressure cooker. See FIG. 17. This is a commonly used configuration for counter-top pressure cookers where the lid is removed and the inner pot 101 is accessible for lidless functions like food-prep, sautéing, browning, or serving. This configuration of use is desirable for the cooking operations discussed herein. During these types of cooking, no pressure cooker lid is propped in the handle. Sometimes when employing the cooker in this manner, a user may wish to cover the cooker with the protective ring 1 and with a lid such as a glass or another aftermarket lid (not shown) that will not allow the pressure cooker to cook under pressure but would be useful as an ordinary pan might be used for keeping warm or yogurt making. By placing the protective ring between the cooker and an aftermarket lid, the ring could offer some protection to the cooker body 102 from boil overs and splashes transferring from the aftermarket lid. During these uses, the condensation catch 103 visible in FIG. 17 would be particularly useful to collect moisture and liquids diverted via the drain channel 1022.

The present invention will also be useful for use when placing a bowl on top, such as in a double boiler application, but only when the heat is off. For this application, water is boiled in the pot, the heat is turned off, the protective ring is applied, and then a secondary bowl is placed on top, such as for use when melting chocolate. The present invention is implemented between the inner pot holding the boiling water and the bowl rim. An advantage of having the present invention in place with the bowl on top is to prevent suction from attaching the bowl to the pot. In preferred embodiments, the present invention is constructed of silicone or similar materials such that it could be depressed to release pressure if this should occur.

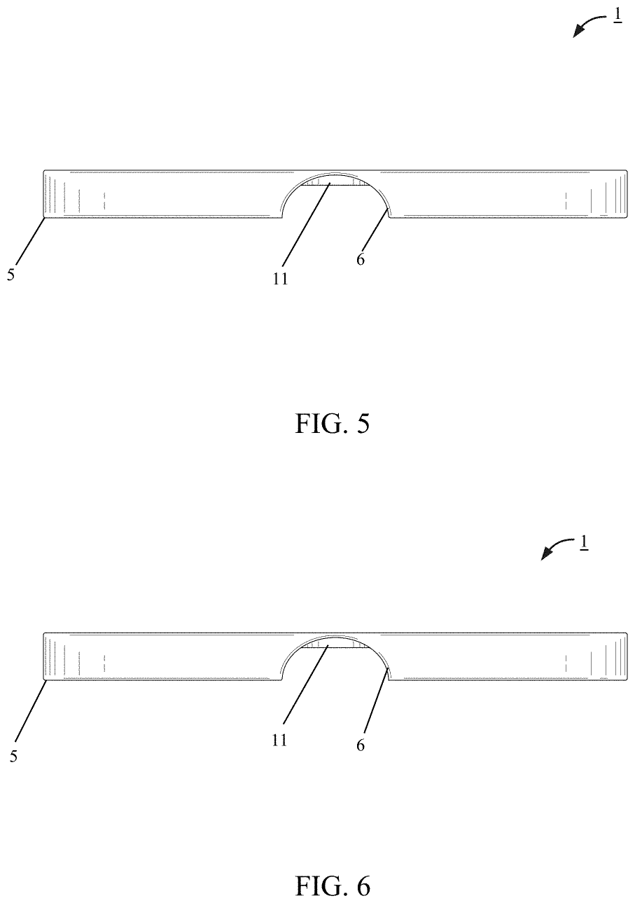

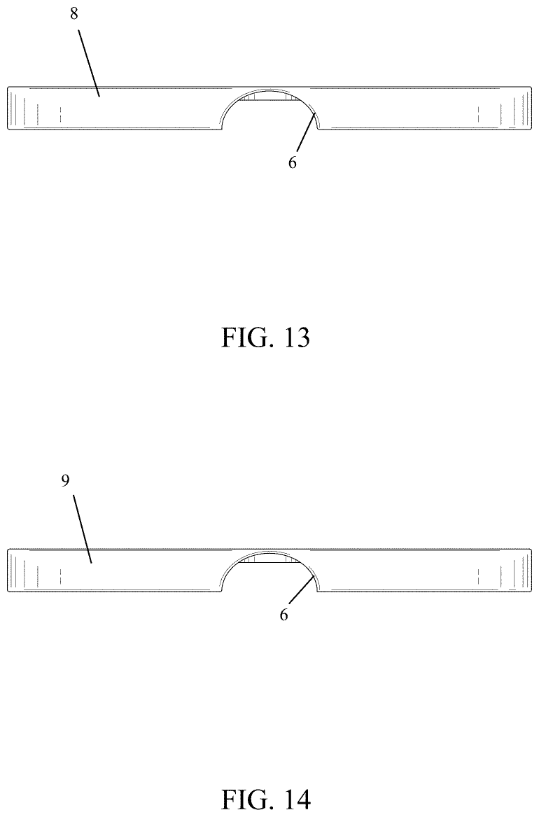

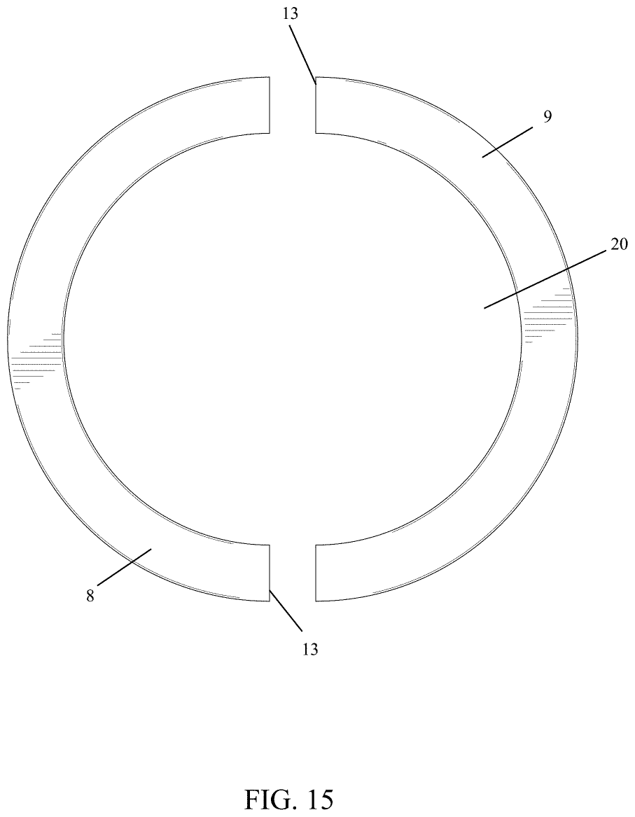

FIGS. 17-18 also illustrate the utility of the lid fin receiving slots 1027 provided by some pressure cooker brands. Either lid fin receiving slot 1027 will cooperate with either fin 1041 of the lid 104. When the lid 104 is turned vertically, its fin 1041 will align with the channel of the lid fin receiving slot 1027. In most Instant Pot® brands, both handles have a lid fin receiving slot 1027 allowing the user the option to use either side to prop the lid in place (see FIG. 17). Certain embodiments of the present invention contemplate this feature and thus the protective ring 1 provides at least one, but particularly two lid fin recesses 6 as illustrated in FIGS. 5-6 and FIGS. 13-14. The prior art cooker shown in FIG. 18 demonstrates the particular utility of the fin lid recess as it permits the present invention's ring to rest in place during use and permits the Instant Pot® lid 104 to sit in the lid fin receiving slot 1027 while the cooker's lid retains the function for the condensation to reach the drain channel 1022 (see, e.g., FIGS. 1 and 17).

The lid fin recesses 6 are further detailed in FIGS. 5-6. The preferred lid fin recess 6 will be formed in an arch with a sufficient length to span the condensation flow area that results when the lid is propped up into the handle of the pressure cooker like shown in FIG. 18. The lid fin recesses 6 allow the normal, engineered flow mechanisms to operate correctly and direct condensation around the drain channel 1022 and into the drain reservoir area 1025 where the condensation may be collected by the condensation catch 103 (see FIG. 17). The lid fin recesses 6 are typically provided in pairs on opposing sides of the protective ring, see FIG. 2. However, a single lid fin recess 6 would be operational for the stated objectives. In this iteration of the invention, a user would simply need to align the lid fin recess 6 with whichever side the lid is propped such as on the right in FIG. 18. The arched shape of the lid fin recess 6 assists in the routing of condensation which will follow a natural course downward and into the drain channel 1022. In FIGS. 5-6, this embodiment of the present invention makes visible the inside wall of the lip 11 through the lid fin recess 6.

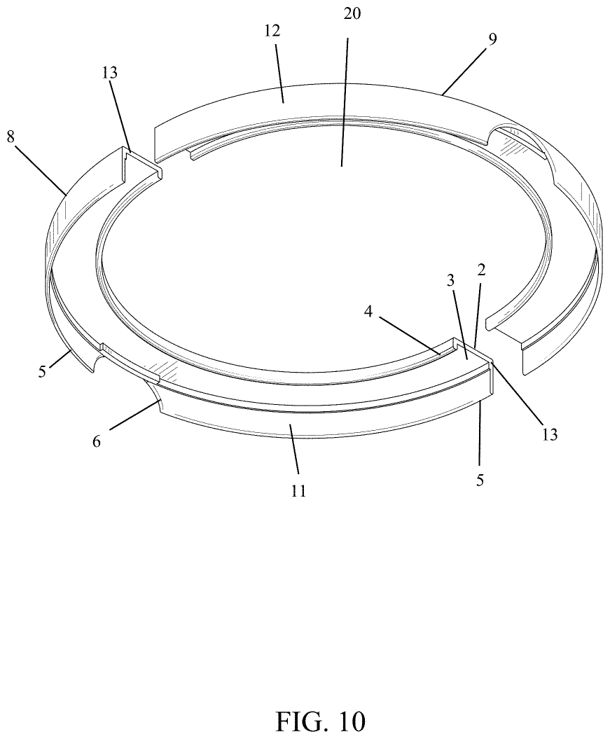

An alternative embodiment of the present invention is demonstrated in FIGS. 9-10. This embodiment includes at least two sections which make up a whole ring 1. The two sections in this embodiment are identical or nearly identical copies of one another and they cooperate such that when they are placed atop a cooker, the rim drain channel 1022 assists in holding them in relative position to one another. As with the one-piece version, the two p-iece embodiment demonstrated in FIG. 9 includes two cut outs 6 which could be placed in various locations around the half-circle device. More cut outs could be provided and the two-piece versions may also operate with only one cut out 6 as with the single piece embodiments shown herein. As best illustrated in FIGS. 9-10, the two-pieces are not fully joined but slightly separated to show their relative body structures. For use, the first piece 8 of the two piece embodiment is brought together with the second piece 9 of the two piece embodiment until a first and second abutting wall join with the complementary walls of the other piece. In modifications of this embodiment, fasteners or mating receivers may be employed to removably secure the two pieces along their abutting walls 13.

With continuing reference to FIG. 9, the upper surface 2 and lower surface 3 are substantially coplanar while the outside wall of the lip 5 and the inside wall of the lip 4 are also coplanar but extend from the lower surface 3 in a substantially perpendicular direction. This embodiment of the present invention includes the lid fin recess 6. In FIGS. 9-10, the inside ledge 4 is visible. This ledge 4, when constructed of silicone can be compressed by the user to grab the inside of the inner pot of the cooker so that the user can slow or stop the spinning of the inner pot 101 in the cooker body 102. This enhances the user's ability to perform the open-top cooking functions described herein.

With reference to FIG. 10, the upper ring surface 2 is shown relative to the lower ring surface 3 and each are abutted by the inside ledge 4 and outer lip 5. The inside wall 11 and outside wall 12 of the lip 5 are visible. The relative sizes of the walls of the inner ledge 4 and the straight, outer lip 5 are visible. In the preferred embodiment, the inside ledge 4 is smaller than the outer lip 5. As further discussed herein, the outer lip 5 may be tapered, even in the two-piece version to permit maximum function of providing cover for the full circumference of the top of the cooker body 102 while permitting the end of the taper of the protective ring 1 to engage fully with the drain channel 1022. FIGS. 9-10, as well as others, make clear the stir-through void 20 is key to the operation of the present invention.

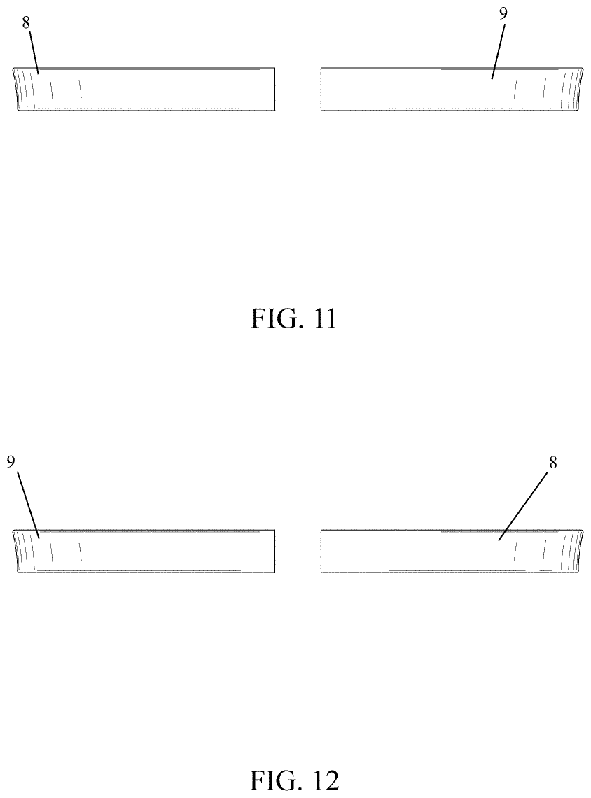

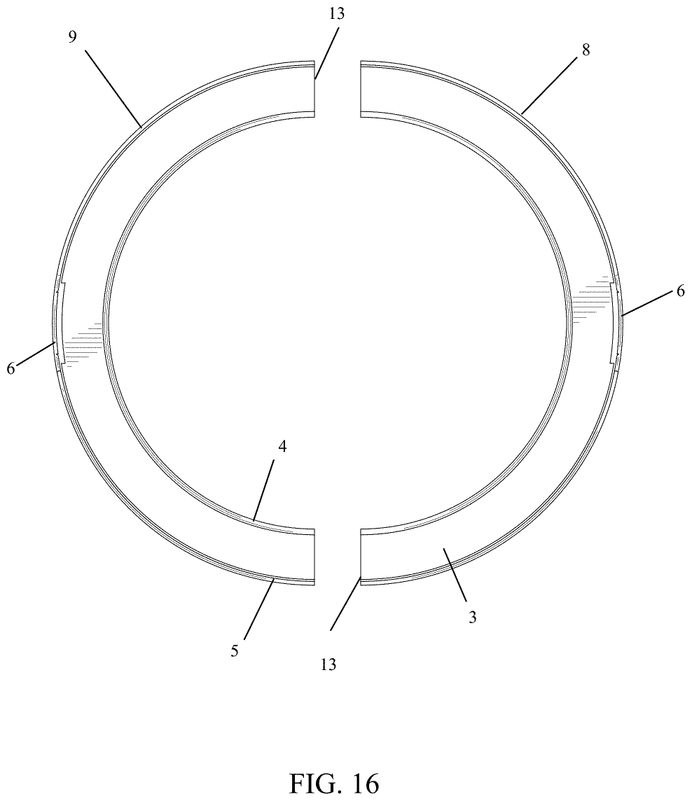

As shown in FIG. 9 and as further detailed in FIGS. 10-16, the demonstrated multipiece embodiment may also incorporate the variations used in the single piece embodiment. FIGS. 9-16 illustrate the multipiece ring with perpendicular outer lip sidewalls. In FIGS. 9-16, the upper ring surface 2 and bottom ring surface 3 and inside ledge 4 and outer lip 5 are all visible. The inside wall 11 and outside wall 12 of the lip are also visible. Each piece of the multipiece embodiment version illustrated in FIGS. 9-16 has a lid fin recess 6, which is spaced away from the abutting walls 13. As an alternative, the lid fin recess 6 could be located at the abutting walls 13.

In alternative embodiments, the protective ring 1 outer lip 5 is configured as a tapered wall. The tapered wall assists in permitting a maximum upper surface diameter but permits the outer lip 5 to terminate at a diameter near or equal to the diameter of the drain channel 1022 (FIG. 17) of the pressure cooker. It is desirable to have the outer lip 5 cooperate with the drain channel 1022 so that any condensation or overflow spills will be routed into the drain channel 1022 rather than spilling over the cooker body 102. By having a tapered wall for the outer edge 5, the objectives of routing condensation in an orderly manner is accomplished and meanwhile the largest diameter of the protective ring 1 can be expanded to provide a splash guard for the majority of the cooker body 102 and the entirety of the cooker rim area. Additional embodiments of the multipiece version would also benefit from a tapered wall for the outer lip.

The present invention shrouds the rim to shield and protect the heating elements and electronics from being damaged or stained during transfer of food or cooking. The protective ring 1 also prevents food from dripping into the drain channel 1022. When liquid boils over, it will damage the element and electronics. This product will cover the opening and prevent or slow the liquid boil over to permit the user to protect the cooker. By covering the pot rim, the cooker body rim structures, and lid receiving recesses of the pressure cooker appliance, the present invention will keep the cooker rim area clean. It will also maintain good hygiene of the cooker. It assists in the overall function of the cooker because food left on the brim of the inner pot can prevent the pot from sealing and coining to pressure which is necessary for the pressure cooker to function correctly.

The exterior pot rim 1021 protrusion repeats around the circumference of the top of the cooker body 102 (see FIG. 17). The removable ring 1 present invention is applied overtop of the top of the cooker 10 only when the cooker lid 104 is not engaged with the lid receiving interface 1023 and the cooker is not being used for the pressure cooker function. However, alternative, aftermarket, glass or metal lids such as those having a consistent rim could be applied overtop of the present invention 1.

The protective ring 1 is to be used whenever the cooker lid 104 is removed, whether standing in the lid fin receiving slot, or set aside. The protective ring 1 is for use while sautéing, searing, adding ingredients, serving, boiling or heating without the lid, and any other time the lid is not in place. With the ring in place, food and liquid will be prevented from getting into the outer pressure cooker housing and damaging or staining the heating element and electronics during the transfer of food and cooking. The ring prevents food from dropping into the drain channel. However, the addition of the ring will assist with the transfer of condensation from the underside of the ring to the drain channel for dripping into the condensation apparatus provided with the pressure cooker.

The preferred embodiment of the protective ring 1 is constructed of a single-piece ring molded of a silicone material. Silicone is advantageously inexpensive, heat resistant and easy to clean by hand or in a dishwasher. Silicone is also compressible to enhance the objective of permitting the user to utilize the present invention to grab the side of the inner pot 101 while stirring, serving or accessing the inner pot 102 during use. Alternative embodiments, whether in one or two piece configurations, are constructed of a more rigid, heat resistant material such as food-grade plastic or hybrid-resin. When constructed of a rigid composite material, the protective ring lends itself easily to 3D printing. The material of construction can be varied to meet the objectives of the invention but will ideally be relatively inexpensive or low cost, food-grade materials, with heat resistant characteristics. The preferred embodiment calls for aesthetically pleasing designs and colors to be employed to please the consumer eye and enhance the attractiveness of the cooking appliance.

By way of example and not by way of limitation, the protective ring will ideally have an outside diameter in the range of 190.5 mm-406.4 mm (7.5-16 inches). The preferred embodiment for the 6 quart Instant Pot® will have a largest diameter of 273.05 mm (10.75 inches). This will allow the ring to accommodate various models of the electric pressure cookers on the market. Likewise, an inside diameter will advantageously occur in the range of 177.8 mm-330.2 mm (7-13 inches) with a ring body spanning the outer diameter and inner diameter. In the preferred embodiment, suited to the 6 quart Instant Pot® cooker, an inner ring opening diameter of 214.487 mm (8.44 inches) is ideal. Other ranges are contemplated to be necessary as the cooking device appliances vary in available sizes and volumes. In particular, it is contemplated a dedicated 3 quart cooker's protective ring would have a diameter between 177.8 mm-215.9 mm (7 and 8.5 inches); a dedicated 6 quart cooker's protective ring would have a diameter between 241.3 mm-279.4 mm (9.5 and 11 inches); a dedicated 8 quart cooker's protective ring would have a diameter between 254 mm-279.4 mm (10 and 11 inches); a dedicated 10 quart cooker's protective ring would have a diameter between 279.4 mm-342.9 mm (11 and 13.5 inches); and a dedicated 14 quart cooker's protective ring would have a diameter between 330.2 mm-406.4 mm (13 and 16 inches). The ring body of the protective ring 1 will rest at a substantially perpendicular angle to the vertical wall of the pot. In the preferred embodiment, the ring body is 25.4 mm-88.9 mm (1-3.5 inches) across. Other widths will be desirable for cooking appliances with thicker heating element housings or larger walled pots. In the preferred embodiment, the height of the device measures 20.64 mm (81 inches) and the opening or cut out for the lid fin on either side of the device has a length of 50 mm (1.97 inches) and may be arched or presented in other configurations. The outer diameter portion of the ring will additionally comprise a lip projecting at an angle that is substantially perpendicular to the ring body. When in use, the lip 5 projects in a downward direction along the exterior portion of the cooking device and extends about 6.35 mm-31.75 mm (25-1.25 inches), about ¼ of the ring body width. The lip 5 helps to secure the ring in place around the outer portion of the rim of the cooking device. The inner diameter portion has a ledge 4 that encircles an opening through which the interior of the pot is accessed for cooking functions. In the preferred embodiment, the thickness of the ring in this embodiment is approximately 1.5 mm (059 inches) and may vary but should be of minimal thickness to permit the material used to achieve the objectives herein.

It is further intended that any other embodiments of the present invention which result from any changes in application or method of use or operation, method of manufacture, shape, size, or material which are not specified within the detailed written description or illustrations contained herein, yet are considered apparent or obvious to one skilled in the art, are within the scope of the present invention.

I claim:

1. A protective ring for application over a rim of an electrical pressure cooker, the protective ring comprising:
an outside circumference,
an inside circumference,
a surface spanning between the outside circumference and the inside circumference,
a vertical edge configured and sized to rest atop an outer portion of the rim of the electric pressure cooker extending from the outside circumference,
the inside circumference being configured and sized to extend inwardly beyond the rim of the electrical pressure cooker.

2. The protective ring of claim 1, wherein the inside circumference is further configured to fully encircle and shroud an inner pot brim of the electrical pressure cooker.

3. The protective ring of claim 1, wherein the outer circumference of the protective ring is slightly smaller than a largest commercially standard diameter of the rim of the electrical pressure cooker.

4. The protective ring of claim 3, wherein the outer circumference has a range between 203.2 mm and 406.4 mm (8 and 16 inches).

5. The protective ring of claim 1, wherein the vertical edge measures in a range of 25.4 mm-50.8 mm (1-2 inches).

6. The protective ring of claim 1, wherein the vertical edge further comprises at least one recess which cooperates with at least one lid structure on the rim of the electrical pressure cooker.

7. The protective ring of claim 6, wherein the at least one recess permits the protective ring to allow condensation to form on an underside of the surface and escape to designated condensation collection features of the electrical pressure cooker.

8. The protective ring of claim 1, wherein the vertical edge is tapered.

9. A method by which a user employing the protective ring of claim 2, cooks utilizing the electrical pressure cooker, wherein cooking steps comprise:
applying the protective ring over the rim of the electrical pressure cooker,
using the electrical pressure cooker to perform the cooking steps.

10. The method of claim 9, wherein the cooking steps may comprise a range of activities from adding ingredients, preparing, stirring, and serving.

11. The method of claim 9, wherein the cooking steps further comprise applying a bowl over the protective ring to complete a double boiler application.

12. The method of claim 9, wherein the protective ring acts to shield the electrical pressure cooker.

13. The method of claim 9, wherein the steps further comprise setting a lid atop the surface of the protective ring, particularly during boiling or slow cooking.

14. The method of claim 9, wherein the steps further comprise installing the protective ring prior to serving contents of the pot.

15. The method of claim 9, wherein the steps further comprise using the protective ring to encircle and protect the rim.

16. The method of claim 9, wherein the steps further comprise using the protective ring to inhibit spinning of the inner pot within an outer housing of the electric pressure cooker.

17. A protective ring for application over a rim of an electrical pressure cooker, the protective ring comprising:
an outside circumference,
an inside circumference,
a surface spanning the outside circumference and the inside circumference,
a vertical edge extending at a substantially perpendicular angle from the outside circumference,
the vertical edge being configured and sized to rest atop the rim of the electric pressure cooker,
an inner ledge extending at a substantially perpendicular angle from the inside circumference, and
the inner ledge being configured and sized to extend beyond the rim of the electrical pressure cooker.

18. The protective ring of claim 17, wherein at least one recess is located in the vertical edge.

19. The protective ring of claim 18, wherein a radius of the least one recess is approximately equal to the height of the vertical edge.

20. The protective ring of claim 17, wherein a reinforcing lip provides support to the surface of the protective ring.
